(19) United States
(12) Patent Application Publication
(10) Pub. No.: US 2006/0021289 A1
(43) Pub. Date: Feb. 2, 2006

(54) Partition wall

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/531,541

(22) PCT Filed: Oct. 22, 2003
(86) PCT No.: PCT/EP03/11700

§ 371 Date: Apr. 15, 2005

(30) Foreign Application Priority Data
Oct. 25, 2002 (DE) 102 50 079.7

(51) Int. Cl. E04B 7/18; E06B 3/68

(52) U.S. Cl. 52/200; 52/204.58; 52/204.6

(57) ABSTRACT

A glass partition includes a pair of frameless glass side parts attached to a floor and a ceiling, and a frameless glass element attached to the side parts and to the ceiling without the use of fittings, the glass element being attached to the side parts and the ceiling exclusively by a permanently elastic compound.

The invention pertains to a partition according to the introductory clause of claim 1.

Glass partitions in which a glass element installed above a doorway, a so-called transom window, is attached to side parts, one on each side, by means of metal fittings, is known from the prospectus “DORMA Universal” (edition of 12/93). These types of visible fittings oppose the general effort to obtain “dematerialized” products. It is complicated and time-consuming to install the fittings, because glass, as a construction material, suffers from certain weaknesses, and the various parts of the fittings must therefore be mounted and adjusted precisely and without stress. Another disadvantage is that the fittings make it difficult to clean the glass surfaces.

The task of the present invention is therefore to create a partition with glass elements which can be attached to side parts and/or to a ceiling construction without the need for fittings.

This task is accomplished by the features stated in claim 1. Advantageous elaborations of the partition are described in the subclaims.

A partition according to claim 1 makes it possible to attach a glass element, e.g., a so-called transom, easily and cheaply to the side parts of a glass partition and to a ceiling construction to form a doorway. There is no need for the complicated work of installing and adjusting hardware fittings. A visually advantageous partition is obtained, which represents an almost completely dematerialized glass surface. Cleaning is much easier, because there are no edges at the fittings where dirt can collect; only a continuous, flat glass front is present. This type of partition is built with the use of frameless panes of glass, so that the cost of framing work is also eliminated.

The transom is attached by means of a permanently elastic compound, which connects the longitudinal edges of the transom to the periphery in a nonpositive manner, namely, to the side parts and to the ceiling construction. To ensure that the connections can withstand the vibrations which occur during normal use, the compound is characterized by permanent elasticity. Acrylic or silicone materials are preferably used for this purpose, especially because they and the methods used to process them are sufficiently well known.

To provide additional protection against vibrations and also to stiffen the glass panes, horizontal stiffeners in the form of glass struts, which project perpendicularly from the surface of the side parts, can be attached to the side parts. The glass struts preferably stand on the floor and are also attached by means of the permanently elastic compound. Through the use of glass for the struts, a uniform and optically attractive front is also created in this respect.

The transom and the side parts are attached to the floor and to the ceiling by the use of profiles, installed on the floor and ceiling. Here again, the permanently elastic compound is used. The profiles are preferably U-shaped.

In a preferred embodiment of the partition, a leaf can be installed in the doorway which has been created underneath the transom and between the side parts. The leaf is supported by means of fittings in such a way that it can swing.

Attaching the transom by means of the permanently elastic compound makes it possible to configure the partitions in various ways. In the simplest arrangement, a completely straight line is produced. Depending on the number of side parts and transoms, many different angled configurations can also be realized. Thus a system built in this way is highly versatile and can be used to produce anything from a simple partition to a complicated partition “landscape”.

Additional details, features, and advantages of the invention can be derived from the following preferred exemplary embodiments, which are described on the basis of the drawings:

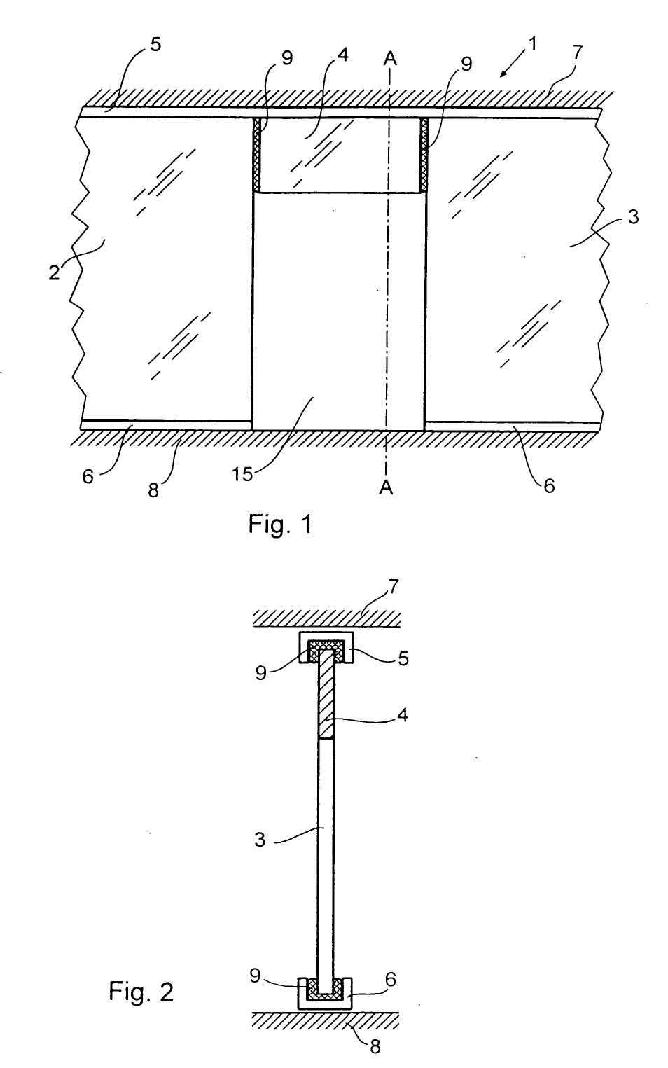

FIG. 1 shows a front view of a partition;

FIG. 2 shows a cross section through the partition along line A-A in FIG. 1;

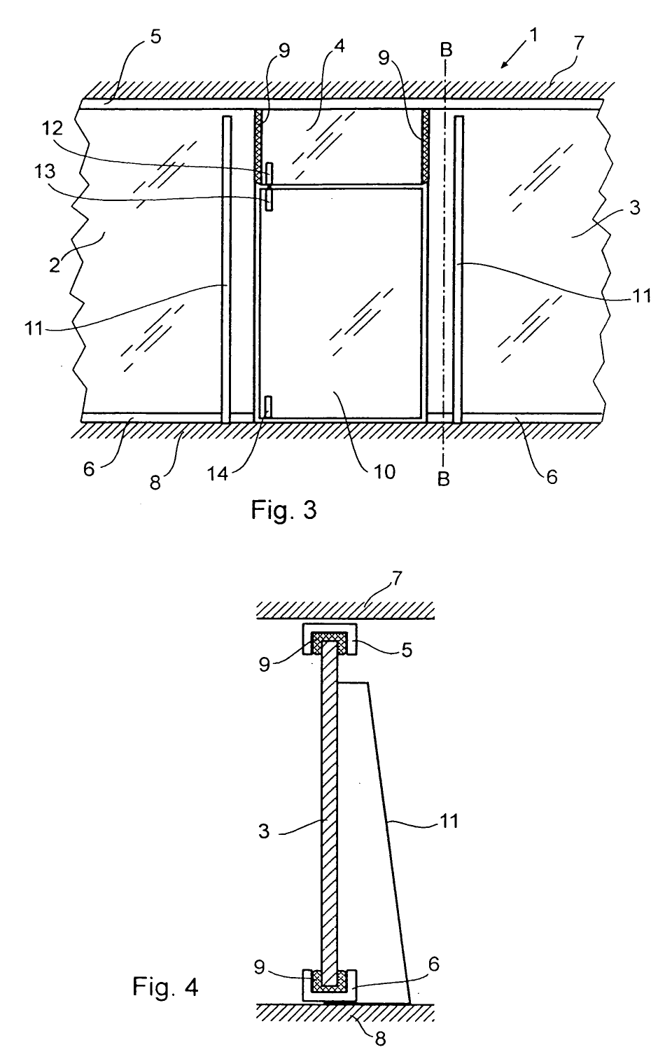

FIG. 3 shows a front view of a partition with an integrated leaf;

FIG. 4 shows a cross section through the partition along line B-B in FIG. 3;

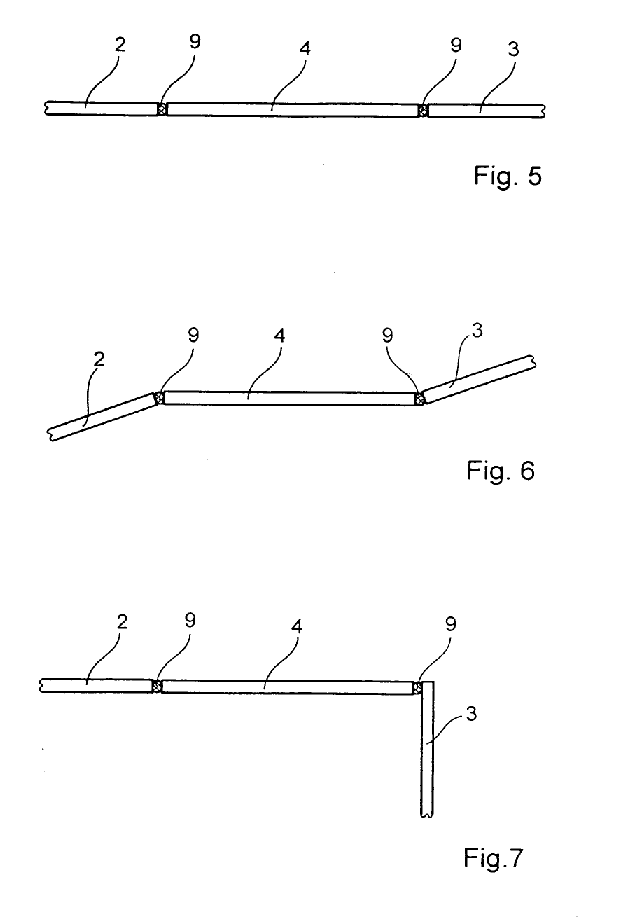

FIG. 5 shows a schematic plan view of the course of a partition;

FIG. 6 shows another schematic plan view of the course of a partition; and

FIG. 7 shows another schematic plan view of the course of a partition.

FIGS. 1 and 2 show a first exemplary embodiment of a partition 1 according to the invention, where the partition 1 extends between a ceiling construction 7 and a floor 8. The partition 1 consists of various frameless glass elements, which are designed to serve as side parts 2, 3 and as a transom 4, located between the side parts 2, 3. This type of transom extends only across the upper area of a partition 1, so that a doorway 15 is created underneath the transom 4 and between the side parts 2, 3. A continuous, preferably U-shaped profile 5 extends along the ceiling construction 7, whereas two U-shaped profiles 6 extend along the floor 8.

The transom 4 is connected along its longitudinal edges to the associated longitudinal edges of the side parts 2, 3 by means of a permanently elastic compound 9 in a nonpositive manner. In addition, the transverse upper edge of the transom 4 is held nonpositively in the ceiling profile 5 by means of the permanently elastic compound 9. The two side parts 2, 3 are also held by means of the permanently elastic compound in corresponding profiles 5 and 6, one on the floor, the other on the ceiling.

FIGS. 3 and 4 show another exemplary embodiment of the invention. The basic arrangement of the partition 1 differs from that of the previously described exemplary embodiment in that a leaf 10 is installed in the doorway 15, formed underneath the transom 4 and between the two side parts 2, 3. This leaf 10 also consists of glass and is supported at the top on the transom 4 and at the bottom on the floor 8 in such a way that it can swing. Suitable fittings 12, 13, 14 are used to attach and to support the leaf 10. As an option, a door closer (not shown) can also be set into the floor 8; this door closer is integrated into the bottom support of the leaf 10 in such a way that the leaf 10 will close automatically after it has been opened manually.

In addition, stiffening elements 11 are attached to the two side parts 2, 3. These elements, which extend horizontally and project perpendicularly, are attached by means of the permanently elastic compound 9. The stiffening elements 11 are designed as glass struts and stand on the floor.

FIGS. 5-7 show schematically several possible ways in which a partition 1 can be configured within the scope of the inventive idea. FIG. 5 shows a completely straight configuration, where a side part 2, a transom 4, and the other side part 3 are arranged next to each other and are attached to each other in a straight line. In FIG. 6, the side parts 2, 3 are arranged and attached at a slight angle to the transom 4. In contrast, FIG. 7 shows a straight course between a side part 2 and a transom 4, to which a side part 3 is attached at a 90° angle.

The description of the exemplary embodiments provided above serves only to illustrate the invention, not to limit it. Various changes and modifications are possible within the framework of the invention without abandoning the scope of the invention or its equivalents.

### LIST OF REFERENCE NUMBERS

1 partition
2 side part
3 side part
4 glass element, transom
5 profile
6 profile
7 ceiling construction
8 floor
9 permanently elastic compound
10 leaf
11 stiffening element, glass strut
12 fitting
13 fitting
14 fitting
15 doorway

1-10. (canceled)

11. A glass partition comprising:
a pair of frameless glass side parts attached to a floor and a ceiling; and
a frameless glass element attached nonpositively to the side parts and to the ceiling exclusively by a permanently elastic compound.

12. The glass partition of claim 11 wherein the permanently elastic compound is at least one of a silicone and an acrylic material.

13. The glass partition of claim 11 wherein the glass side parts each have a longitudinal edge, the glass element having a pair of longitudinal edges which are attached to respective longitudinal edges of the side parts.

14. The glass partition of claim 11 further comprising a channel installed on the ceiling, the side parts and the glass element being received in the channel and attached nonpositively to the channel by the permanent elastic compound.

15. The glass partition of claim 11 further comprising a pair of channels installed on the floor, the side parts being received in respective said channels and attached nonpositively to the channels by the permanent elastic compound.

16. The glass partition of claim 11 further comprising a pair of vertically oriented stiffening elements attached to the side parts at right angles.

17. The glass partition of claim 16 wherein the stiffening elements are attached to the side parts by the permanently elastic compound.

18. The glass partition of claim 11 further comprising a door installed between the side parts and below the glass element.

19. The partition of claim 11 wherein the side parts and the glass element are coplanar.

20. The partition of claim 11 wherein the side parts lie in planes forming an acute angle with the plane of the glass element.
